(19) United States
(12) Patent Application Publication
(10) Pub. No.: US 2003/0115410 A1
(43) Pub. Date: Jun. 19, 2003

(54) Method and apparatus for improving file system response time

(75) Inventor: Elizabeth Shriver, Jersey City, NJ (US)

Correspondence Address: Ryan, Mason & Lewis, LLP, Suite 205, 1300 Post Road, Fairfield, CT, 06430, US

(73) Assignee: Lucent Technologies Inc.

(21) Appl. No.: 10/356,306

(22) Filed: Jan. 31, 2003

Related U.S. Application Data
(63) Continuation of application No. 09/325,069, filed on Jun. 3, 1999.

(51) Int. Cl. G06F 12/00

(52) U.S. Cl. 711/113; 711/137

(57) ABSTRACT

A method and apparatus are disclosed for improving file system response time. File system response time is improved by reading an entire cluster each time a read request is received. When a request to read the first one or more bytes of a file arrives at the file system, the file system assumes the file is being read sequentially and reads the entire first cluster of the file into the file system cache. File system response time is also improved by modifying the number of disk cache segments. The number of disk cache segments restricts the number of sequential workloads for which the disk cache can perform readahead. The disclosed file system dynamically modifies the number of disk cache segments to be at least the number of files being concurrently accessed from a given disk. In one implementation, the number of disk cache segments is set to one more than the number of sequential files being concurrently accessed from that disk, so that the additional cache segment can service the randomly-accessed files.

### CROSS REFERENCE TO RELATED APPLICATIONS

This application is a continuation of U.S. patent application Ser. No. 09/325,069, filed Jun. 3, 1999, incorporated by reference herein.

### FIELD OF THE INVENTION

The present invention relates generally to techniques for improving file system performance, and more particularly, to a method and apparatus for improving the response time of a file system.

### BACKGROUND OF THE INVENTION

File systems process requests from application programs for an arbitrarily large amount of data from a file. To process an application-level read request, the file system typically divides the request into one or more block-sized (and block-aligned) requests, each separately processed by the file system. For each block in the request, the file system determines whether the block already resides in the cache memory of the operating system. If the block is found in the file system cache, then the block is copied from the cache to the application. If, however, the block is not found in the file system cache, then the file system issues a read request to the disk device driver.

Regardless of whether the requested block of data is already in the file system cache, the file system may prefetch one or more subsequent blocks from the same file. File systems often attempt to maximize performance and reduce latency by predicting the disk blocks that are likely to be requested at some future time and then prefetching such blocks from disk into memory. Prefetching blocks that are likely to be requested at some future time improves file system performance for a number of reasons.

First, there is a fixed cost associated with performing any disk input/output operation. Thus, by increasing the amount of data that is transferred for each input/output operation, the overhead is amortized over a larger amount of data, thereby improving overall performance. In addition, most disk systems utilize a disk cache (separate from the file system cache) that contains a number of disk blocks from the cylinders of recent requests. If multiple blocks are read from the same track, all but the first block may often be satisfied by the disk cache without having to access the disk surface. Since the data may already be in the disk cache as a result of a read-ahead for a previous command, in a known manner, the disk does not need to read the data again. In this case, the disk sends the data directly from the disk cache. If the data is not found in the disk cache, the data must be read from the disk surface.

The device driver or disk controller can sort disk requests to minimize the total amount of disk head positioning that must be performed. For example, the device driver may implement an “elevator” algorithm to service requests in the order that they appear on the disk tracks. Likewise, the disk controller may implement a “shortest positioning time first” algorithm to service requests in an order intended to minimize the sum of the seek time (the time to move the head from the current track to the desired track) and the rotational latency (the time needed for the disk to rotate to the correct sector once the desired track is reached). With a larger list of disk requests (associated with requested data and prefetched data), the driver or controller can do a better job of ordering the disk requests to minimize disk head motions. In addition, the blocks of a file are often clustered together on the disk, thus multiple blocks of the file can be read at once without an intervening seek.

Read requests are typically synchronous. Thus, the operating system generally blocks the application until all of the requested data is available. It is noted that a single disk request may span multiple blocks and includes both the requested data and prefetched data, in which case the application cannot continue until the entire request completes. If an application performs substantial computations as well as input/output operations, the prefetching of data in this manner may allow the application to overlap the computations with the input/output operations, to increase the applications throughput. If, for example, an application spends as much time performing input/output operations as the application spends computing, the prefetching of data allows overlapping the input/output and computing operations to increase the throughput of the application by a factor of two.

Conventional techniques for evaluating prefetching strategies actually implement the prefetching strategy to be evaluated on the target file system. Thereafter, the prefetching strategy is tested and the experimental results are compared to one or more benchmarks. Of course, the design, implementation and testing of a file system is often an expensive and time-consuming process.

As apparent from the above-described deficiencies with conventional techniques for evaluating file system performance, a need exists for a method and apparatus for predicting the response time of a simulated version of a target file system. A further need exists for an analytical model that simulates the hardware environment and prefetching strategies to thereby evaluate file system performance. Yet another need exists for a system that evaluates the relative benefits of each of the various causes that contribute to performance improvements on techniques for increasing the effectiveness of prefetching.

### SUMMARY OF THE INVENTION

Generally, a method and apparatus are disclosed for improving file system response time. According to one aspect of the invention, a method and apparatus are provided for improving file system response time by reading an entire cluster each time a read request is received. Thus, the present invention assumes that a file is being read sequentially, and reads an entire cluster each time the disk head is positioned over a cluster.

When a request to read the first one or more bytes of a file arrives at the file system, the file system assumes the file is being read sequentially and reads the entire first cluster of the file into the file system cache. Thus, the present invention may be viewed as initializing the prefetching window to the maximum allowable value. This feature of the invention decreases the latency when an application requests future reads from the file. When it is detected that a file is not being accessed sequentially, the standard or default prefetching technique will be used.

According to another aspect of the invention, a method and apparatus are provided for improving file system response time by modifying the number of disk cache segments. The number of disk cache segments restricts the number of sequential workloads for which the disk cache can perform readahead. The disclosed file system dynamically modifies the number of disk cache segments to be at least the number of files being concurrently accessed from a given disk. In one implementation, the number of disk cache segments is set to one more than the number of sequential files being concurrently accessed from that disk, so that the additional cache segment can service the randomly-accessed files. Thus, the file system determines the number of concurrent files being accessed sequentially, and establishes the number of disk cache segments to be at least the number of files being accessed concurrently and sequentially.

A more complete understanding of the present invention, as well as further features and advantages of the present invention, will be obtained by reference to the following detailed description and drawings.

### BRIEF DESCRIPTION OF THE DRAWINGS

FIG. 1 illustrates a file system evaluator in accordance with the present invention;

FIG. 2 is a sample table from the file system specification of FIG. 1;

FIG. 3 is a sample table from the disk specification of FIG. 1;

FIG. 4 is a sample table from the workload specification of FIG. 1;

FIG. 5 is a flow chart describing an exemplary disk response time (DRT) process implemented by the file system evaluator of FIG. 1; and

FIG. 6 is a flow chart describing an exemplary file system response time (FSRT) process implemented by the file system evaluator of FIG. 1.

### DETAILED DESCRIPTION

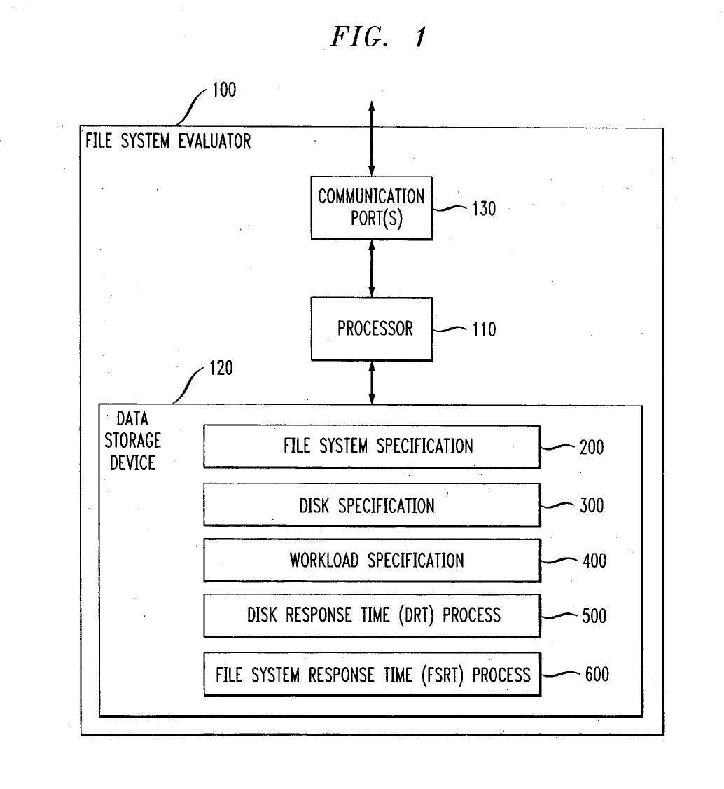

FIG. 1 illustrates a file system evaluator 100, in accordance with the present invention. The file system evaluator 100 evaluates the performance of a simulated file system. More precisely, the present invention provides a method and apparatus for predicting the response time of read operations performed by a file system using analytic models. In other words, the present invention predicts the time to read a file as a function of the characteristics of the file system and corresponding hardware. In this manner, a proposed file system can be evaluated without incurring the development costs and time delays associated with implementing an actual test model. Furthermore, the present invention allows a file system developer to vary and evaluate various potential file system layouts, prefetching policies or other file system parameters to obtain system parameter settings exhibiting improved file system performance.

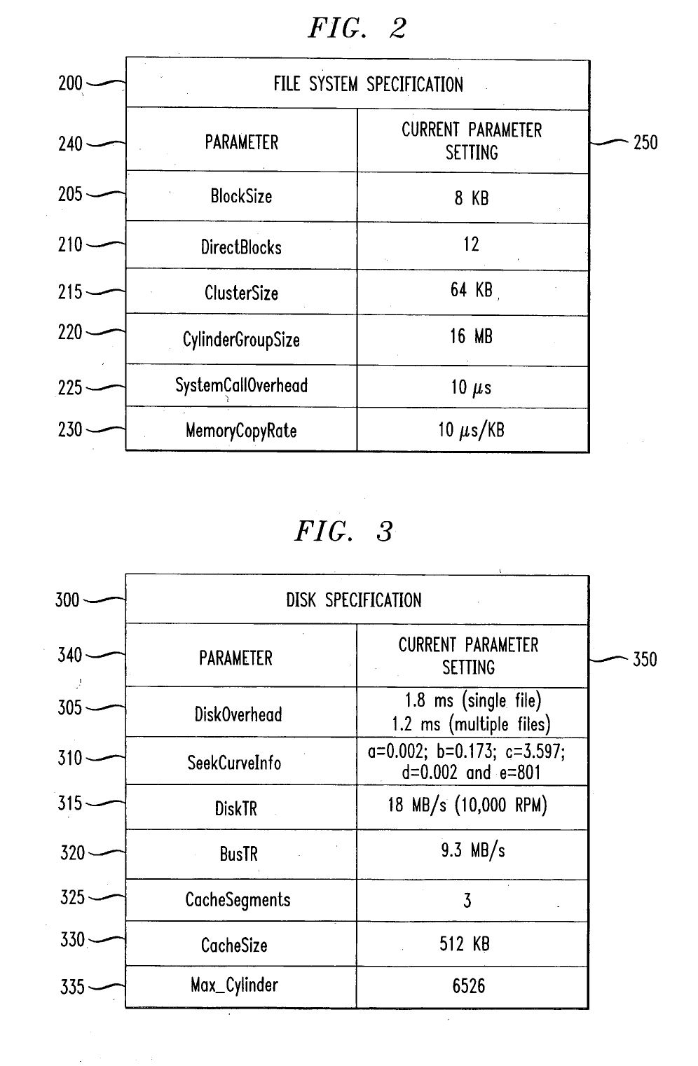

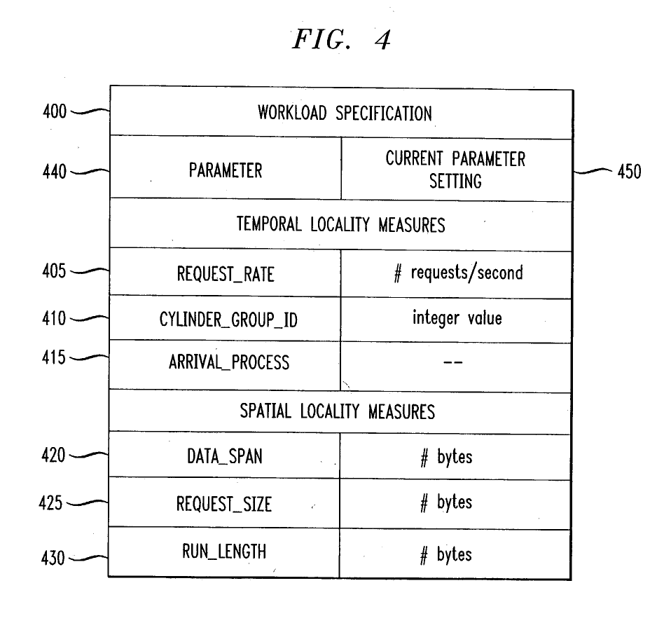

The file system evaluator 100 of the present invention is parameterized by the behavior of the file system, such as file system prefetching strategy and file layout, and takes into account the behavioral characteristics of the disks (hardware) used to store files. In the illustrative implementation shown in FIG. 1, the present invention models a file system using three sets of parameters, namely, a file system specification 200, a disk specification 300, and a workload specification 400. The file system specification 200, discussed below in conjunction with FIG. 2, models the performance of the file system cache and describes the operating system or file system characteristics that control how the memory is allocated. The disk specification 300, discussed below in conjunction with FIG. 3, models the disk response time and describes the hardware of the file system, including the disk and controller. The workload specification 400, discussed below in conjunction with FIG. 4, models the workload parameters that affect file system cache performance and describes the workload or type of applications to be processed by the file system.

Thus, the file system specification 200 allows the present invention to capture the performance of the file system cache. The disk specification 300 and workload specification 400 allows the present invention to predict the disk response time (DRT). The workload specification 400 allows the present invention to model the workload parameters that affect file system cache performance.

The amount of data that is prefetched by a file system is determined by the prefetching policy of the file system, and is a function of the current file offset and whether or not the application has been accessing the file sequentially. A read operation of a block, x, is generally considered sequential if the previous block read from the same file was block x or block x-1. In this manner, successive reads of the same block are treated as sequential, so that applications are not penalized for using a read size that is less than the block size of the file system.

FIG. 1 is a block diagram showing the architecture of an illustrative file system evaluator 100. The file system evaluator 100 may be embodied, for example, as a workstation, or another computing device, as modified herein to execute the functions and operations of the present invention. The file system evaluator 100 includes a processor 110 and related memory, such as a data storage device 120. The processor 110 may be embodied as a single processor, or a number of processors operating in parallel. The data storage device 120 and/or a read only memory (ROM) are operable to store one or more instructions, which the processor 110 is operable to retrieve, interpret and execute.

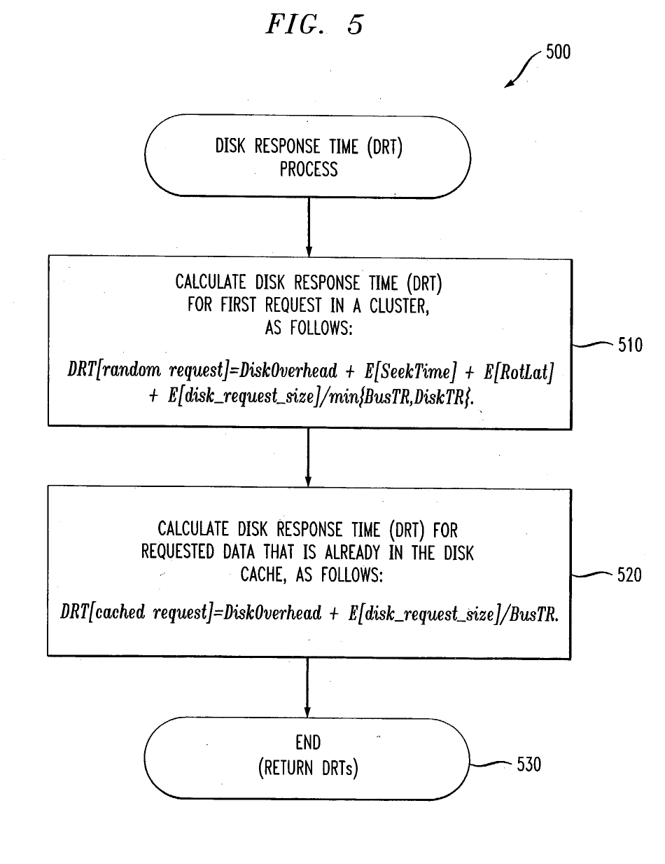

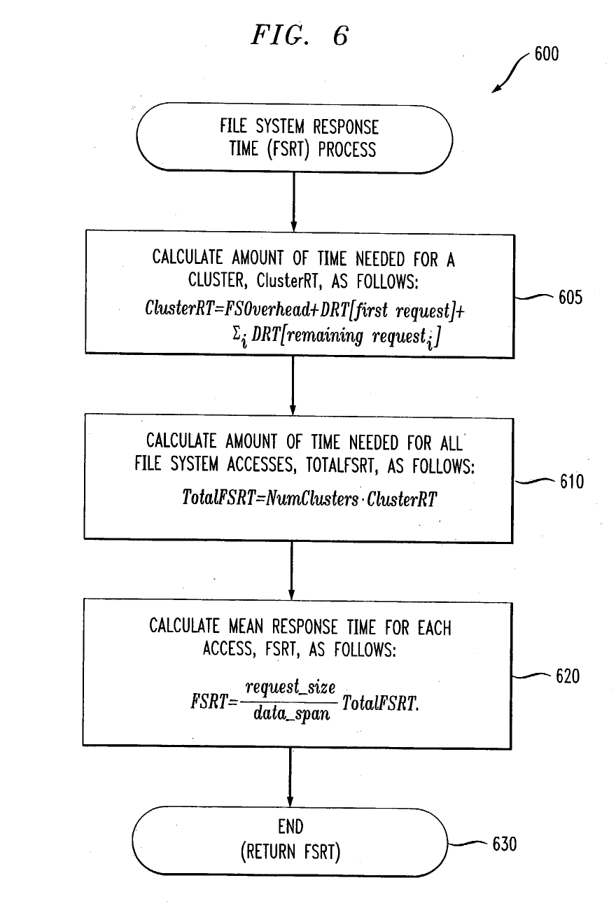

As discussed above, in the illustrative implementation, the data storage device 120 includes three sets of parameters to model a file system. Specifically, the data storage device 120 includes a file system specification 200, a disk specification 300, and a workload specification 400, discussed further below in conjunction with FIGS. 2 through 4, respectively. In addition, the data storage device 120 includes a disk response time (DRT) process 500 and a file system response time (FSRT) process 600, discussed further below in conjunction with FIGS. 5 and 6, respectively. Generally, the disk response time (DRT) process 500 calculates the mean disk response time (DRT) of the file system. Although generally considered an intermediate result, the mean disk response time (DRT) is often of interest. The file system response time (FSRT) process 600 computes the file system response time (FSRT), thereby providing an objective measure of the performance of the simulated file system.

An optional communications port 130 connects the file system evaluator 100 to a network environment (not shown), thereby linking the file system evaluator 100 to each connected node in the network environment.

### File System Terminology and Operation

File System Specification 200

FIG. 2 illustrates an exemplary file system specification 200 that preferably models the performance of the file system cache and describes the operating system or file system characteristics that control how the memory is allocated. The file system specification 200 maintains a plurality of records, such as records 205-230, each associated with a different file system parameter. For each file system parameter listed in field 240, the file system specification 200 indicates the current parameter setting in field 250.

For example, a cluster is a group of logically sequential file blocks of a given size, referred to as the BlockSize, set forth in record 205, that are stored sequentially on a disk. The cluster size, ClusterSize set forth in record 215, is the number of bytes in the cluster. Many file systems place successive allocations of clusters contiguously on the disk, resulting in contiguous allocations of hundreds of kilo-bytes in size. The blocks of a file are typically indexed by a tree structure on the disk, with the root of the tree being an “inode.” The inode contains the disk addresses to the first few blocks of a file. In other words, the inode contains the first “direct blocks” of the file. The remaining blocks are referenced by indirect blocks. The first block referenced from an indirect block is always the start of a new cluster. Thus, the preceding cluster may have to be smaller than the cluster size of the file system. The value DirectBlocks (record 210) indicates the number of blocks that can be accessed before the indirect block needs to be accessed.

The file system divides the disk into cylinder groups, which are used as allocation pools. Each cylinder group contains a fixed sized number of blocks (or bytes), referred to as the CylinderGroupSize (record 220). The file system exploits expected patterns of locality of reference by co-locating related data in the same cylinder group. The value SystemCallOverhead, set forth in record 225, indicates the time needed to check the file system cache for the requested data. The value MemoryCopyRate, set forth in record 230, indicates the rate at which data are copied from the file system cache to the application memory.

It is noted that a file system usually attempts to allocate clusters for the same file in the same cylinder group. Each cluster is allocated in the same cylinder group as the previous cluster. The file system attempts to space clusters according to the value of the rotational delay parameter. The file system can always achieve this desired spacing on an empty file system. If the free space on the file system is fragmented, however, this spacing may vary. The file system allocates the first cluster of a file from the same cylinder group as the inode of the file. Whenever an indirect block is allocated to a file, allocation for the file switches to a different cylinder group. Thus, an indirect block and the clusters referenced by the indirect block are allocated in a different cylinder group than the previous part of the file.

Disk Specification 300

FIG. 3 illustrates an exemplary disk specification 300 that preferably models the disk response time and describes the hardware of the file system, including the disk and controller. The disk specification 300 maintains a plurality of records, such as records 305-335, each associated with a different disk parameter. For each disk parameter listed in field 340, the disk specification 300 indicates the current parameter setting in field 350.

The value, DiskOverhead, set forth in record 305 includes the time to send a request down the bus and the processing time at the controller, which includes the time required for the controller to parse the request and check the disk cache for the data. The DiskOverhead value can be approximated using a complex disk model, as discussed in E. Shriver, “Performance Modeling for Realistic Storage Devices,” Ph.D Thesis, Dept. of Computer Science, New York University, New York, N.Y. (May, 1997), available from www.bell-labs.com/˜shriver/, and incorporated by reference herein. Alternatively, the DiskOverhead value can be measured experimentally.

The value, SeekCurveInfo, set forth in record 310 is used to approximate the seek time (the time for the actuator to move the disk arm to the desired cylinder), where a, b, c, d and e are device specific parameters. For a discussion of the seek curve parameters (a, b, c, d and e), see, E. Shriver, “Performance Modeling for Realistic Storage Devices,” Ph.D Thesis, incorporated by reference above.

The manufacturer-specified disk rotation speed is used to approximate the time spent in rotational latency [RotLat]. The Disk Transfer Rate, denoted as DiskTR, set forth in record 315, is the rate that data can be transferred from the disk surface to the disk cache. The Bus Transfer Rate, denoted as BusTR, set forth in record 320 indicates the rate at which data can be transferred from the disk cache to the host. The slower of the BusTR and the DiskTR is the bound.

It is again noted that there are typically two caches of interest, namely, a file system cache, and a disk cache. The disk cache is divided into cache segments. Each cache segment contains data that is prefetched from the disk for one sequential stream. The number of cache segments, denoted CacheSegments, set forth in record 325, usually can be set on a per-disk basis, and typically has a value between one and sixteen. The value CacheSegments is the number of different data streams that the disk can concurrently cache, and hence the number of streams for which it can perform read-ahead.

The value CacheSize, set forth in record 330, indicates the size of the disk cache. From the CacheSize value and the CacheSegments value, the size of each cache segment can be computed. The value Max_Cylinder, set forth in record 335 indicates the number of cylinders in the disk.

When a request reaches the head of the queue, the disk checks to see if the requested block(s) are in the disk cache. If the requested block(s) are not in the disk cache, the disk mechanism moves the disk head to the desired track (seeking) and waits until the desired sector is under the head (rotational latency). The disk then reads the desired data into the disk cache. The disk controller then contends for access to the bus, and transfers the data to the host from the disk cache at a rate determined by the speed of the bus controller and the bus itself. Once the host receives the data and copies the data into the memory space of the file system, the file system awakens any processes that are waiting for the read operation to complete.

Workload Specification 400

Generally, the workload specification 400 characterizes the nature of calls (requests) from an application and their temporal and spatial relationships. The workload parameters that affect file system cache performance are the ones needed to predict the disk performance and the file layout on disk. FIG. 4 illustrates an exemplary workload specification 400 that preferably models the workload parameters that affect file system cache performance and describes the workload or type of applications to be processed by the file system. The workload specification 400 maintains a plurality of records, such as records 405-430, each associated with a workload parameter. For each workload parameter listed in field 440, the workload specification 400 indicates the current parameter setting in field 450.

As shown in FIG. 4, the value Request Rate, set forth in record 405, indicates the rate at which requests arrive at the file system. The value Cylinder_Group_ID, set forth in record 410, indicates the cylinder group (location) of the file. The value Arrival_Process, set forth in record 415, indicates the inter-request timing (constant [open, closed], Poisson, or bursty). The value Data_Span, set forth in record 420, indicates the span (range) of data accessed. The value Request_Size, set forth in record 425, indicates the length of an application read or write request. Finally, the value Run_Length, set forth in record 430, indicates the length of a run (a contiguous set of requests). For a more detailed discussion of disk modeling, see, for example, E. Shriver et al., “An Analytic Behavior Model for Disk Drives with Readahead Caches and Request Reordering,” Joint Int'l Conf. on Measurement and Modeling of Computer System (Sigmetrics '98/Performance '98), 182-91 (Madison, Wis., June 1998), available from www.bell-labs.com/˜shriver/, and incorporated by reference herein.

### The Analytic Model

Disk Response Time

As previously indicated, the disk response time (DRT) process 500, shown in FIG. 5, calculates the mean disk response time (DRT) of the file system. Although generally considered an intermediate result (and used in the calculation of the file system response time (FSRT)), the mean disk response time (DRT) is often of interest.

As discussed further below, the mean disk response time is the sum of the disk overhead, disk head positioning time, and the time to transfer the data from the disk to the file system cache. In other words, the Disk Response Time (DRT) can be expressed as follows:

$$DRT = DiskOverhead + PositionTime + E [ disk\_request \_size ] / min \{ BusTR , DiskTR \} .$$

It is noted that the expression E[x] denotes the expected, or average value for x. The amount of time spent positioning the disk head, PositionTime, depends on the current location of the disk head, which is determined by the previous request. For example, if a current request if the first request for a block in a given cluster, then the value PositionTime will include both the seek time and the time for rotational latency. E[SeekTime] is the mean seek time and E[RotLat] is the mean rotational latency (half the time for a full disk rotation). Thus, as shown in FIG. 5, the Disk Response Time (DRT) for the first request in a cluster can be calculated during step 510 using the following expression:

$$DRT [ random request ] = DiskOverhead + E [ SeekTime ] + E [ RotLat ] + E [ disk\_request \_size ] / min \{ BusTR , DiskTR \} .$$

If the previous request was for a block in the same cylinder group, the seek distance will be small. If there are n files being accessed concurrently, the expected seek distance will be either (a) Max_Cylinder/3, if the device driver and disk controller request queues are empty, or (b) Max_Cylinder/(n+2), assuming the disk scheduler is using an elevator scheduling algorithm.

The mean disk request size, E[disk_request_size], can be computed by averaging the request sizes. The request sizes can be obtained by simulating the algorithm to determine the amount of data prefetched, where simulation stops when the amount of accessed data is equal to ClusterSize. If the file system is servicing more than one file, the actual amount prefetched can be smaller than expected due to blocks being evicted before use. If the file system is not prefetching data, the mean disk request size, E[disk_request_size], is the file system block size, BlockSize.

As previously indicated, the requested data may already be in the disk cache due to readahead. The Disk Response Time (DRT) is calculated during step 520 for requested data that is already in the disk cache, using the following equation:

DRT[cached request]=DiskOverhead+E[disk_request_size]/BusTR.

As shown in FIG. 5, the execution of the disk response time (DRT) process 500 terminates during step 530 and returns the calculated disk response times (DRTs) for the cases of whether or not the requested data is found in the cache.

File System Response Time

As previously indicated, the file system response time (FSRT) process 600, shown in FIG. 6, computes the file system response time (FSRT), thereby providing an objective measure of the performance of the simulated file system. Generally, the amount of time needed for all of the file system accesses, TotalFSRT, is initially computed, and then the mean response time for each access, FSRT, is computed, by averaging:

$$FSRT = \frac{request\_size}{data\_span} TotalFSRT .$$

For a single file residing entirely in one cluster, the mean response time to read the cluster contains file system overhead plus the time needed to access the data from the disk. The mean response time to read the cluster, ClusterRT, can be expressed as follows:

$$ClusterRT = FSOverhead + DRT [ first request ] + {\sum }_{i} DRT [ remaining {request}_{i} ]$$

where the first request and remaining requests are the disk requests for the blocks in the cluster and DRT[first request] is from step 510 (FIG. 5). If n files are being serviced at once, the DRT[remaining requestᵢ] each contain E[SeekTime] and E[RotLat] if n is more than CacheSegments, the number of disk cache segments. If not, some of the data will be in the disk cache and the equation set forth in step 520 (FIG. 5) is used. The FSOverhead can be measured experimentally or computed as follows:

FSOverhead=SystemCallOverhead+E[request_size]/MemoryCopyRate.

The number of requests per cluster can be computed as data_span/disk_request_size.

As shown in FIG. 6, the amount of time needed for a cluster, ClusterRT, is computed during step 605, as follows:

$$ClusterRT = FSOverhead + DRT [ first request ] + {\sum }_{i} DRT [ remaining {request}_{i} ]$$

Thereafter, the amount of time needed for all of the file system accesses, TotalFSRT, is computed during step 610 for a file spanning multiple clusters, using the following equation:

TotalFSRT=NumClusters·ClusterRT

where the number of clusters, NumClusters, is approximated as data_span/ClusterSize. To capture the “extra” cluster due to only the first DirectBlocks blocks being stored on the same cluster, this value is incremented by one if (ClusterSize/BlockSize)/DirectBlocks does not equal one and data_span/BlockSize is greater than DirectBlocks.

If the device driver or disk controller scheduling algorithm is CLOOK or CSCAN, and the queue is not zero, then there is a large seek time (for CLOOK) or a full stroke seek time (for CSCAN) for each group of n accesses, when n is the number of files being serviced by the file system. This seek time is referred to as the extra_seek_time.

It is noted that if the n files being read are larger than DirectBlocks, then the time required to read the indirect blocks must be included as follows:

TotalFSRT=n·Num Clusters·ClusterRT+num_requests·extra_seek_time+DRT[indirect block].

where num_requests is the number of disk requests in a file. Since the location of the indirect block is on a random cylinder group, the equation set forth in step 510 (FIG. 5) is used to compute the Disk Response Time (DRT) [indirect block]. Of course, if the file contains more blocks than can be referenced by both the inode and the indirect block, multiple indirect block terms are required.

Thereafter, the mean response time for each access, FSRT, is computed during step 620, by averaging as follows:

$$FSRT = \frac{request\_size}{data\_span} TotalFSRT .$$

As shown in FIG. 6, the execution of the file system response time (FSRT) process 600 terminates during step 630 and returns the calculated mean response time for each access, FSRT.

### Techniques for Improving File System Performance

Most files are read sequentially. According to another feature of the present invention, when a request to read the first one or more bytes of a file arrives at the file system, the file system should read the entire first cluster of the file into the file system cache. Of course, the prefetching of future clusters would continue in the same manner. In other words, when the last block of the cluster has been requested by the application, the file system will prefetch the entire next cluster. Another way to view this feature of the present invention is as initializing the prefetching window to be the maximum allowable value, rather than the minimum allowable value. This suggestion should decrease the latency when the application requests future reads from the file. When it is detected that a file is not being accessed sequentially, the standard or default prefetching technique will be used.

Thus, if it is reasonable to assume that prefetched data will be used, and there is room in the file system cache, the entire cluster should be read, once the disk head is positioned over a cluster. In this manner, the file system and disk overheads are decreased. Thus, the present invention assumes that a file is being read sequentially, and reads an entire cluster each time the disk head is positioned over a cluster.

The number of disk cache segments restricts the number of sequential workloads for which the disk cache can perform readahead. Thus, if the number of disk cache segments is less than the number of concurrent workloads, the disk cache might not positively affect the response time. According to a further feature of the present invention, the file system dynamically modifies the number of disk cache segments to be at least the number of files being concurrently accessed from a given disk. In one implementation, the number of disk cache segments is set to one more than the number of sequential files being concurrently accessed from that disk, so that the additional cache segment can service the randomly-accessed files. Thus, the file system determines the number of concurrent files being accessed sequentially, and establishes the number of disk cache segments to be at least the number of files being accessed concurrently and sequentially.

It is to be understood that the embodiments and variations shown and described herein are merely illustrative of the principles of this invention and that various modifications may be implemented by those skilled in the art without departing from the scope and spirit of the invention.

I claim:

1. A method for improving the response time of a file system, comprising the steps of:
receiving a request to read at least a portion of a cluster of a file, wherein said cluster is a plurality of logically sequential file blocks; and
reading said entire cluster each time at least a portion of said cluster is requested independent of whether said file is compressed.

2. The method of claim 1, further comprising the step of evaluating a model of said file system to determine the percentage of prefetched data that is utilized.

3. The method of claim 1, further comprising the step of returning a file system prefetching strategy for said file to a default prefetching strategy if said file is not read sequentially.

4. The method of claim 1, wherein said entire cluster is read into a file system cache.

5. The method of claim 1, further comprising the step of initializing a prefetching window of said file system to a maximum allowable value.

6. A method for improving the response time of a file system, said method comprising the steps of:
determining a number of concurrent requests that each read at least a portion of a unique file;
modifying a number of disk cache segments to be at least said determined number; and
reading each of said unique files into a corresponding disk cache segment.

7. The method of claim 6, further comprising the step of ensuring that each of said files are read sequentially.

8. The method of claim 6, wherein an entire cluster of each file is read into a file system cache.

9. The method of claim 6, wherein said modifying step sets the number of disk cache segments to one more than the number of said files being concurrently accessed from a disk.

10. The method of claim 9, wherein said one more cache segment services randomly-accessed files.

11. A system for improving the response time of a file system, comprising:
a memory for storing computer-readable code; and
a processor operatively coupled to said memory, said processor configured to:
receive a request to read at least a portion of a cluster of a file, wherein said cluster is a plurality of logically sequential file blocks; and
read said entire cluster each time at least a portion of said cluster is requested independent of whether said file is compressed.

12. The system of claim 11, wherein said processor is further configured to evaluate a model of said file system to determine the percentage of prefetched data that is utilized.

13. The system of claim 11, wherein said processor is further configured to return said file system to a default prefetching strategy if said file is not read sequentially.

14. The system of claim 1, wherein said entire cluster is read into a file system cache.

15. The system of claim 11, wherein said processor is further configured to initialize a prefetching window of said file system to a maximum allowable value.

16. A system for improving the response time of a file system, comprising:
a memory for storing computer-readable code; and
a processor operatively coupled to said memory, said processor configured to:
determine a number of concurrent requests that each read at least a portion of a unique file;
modify a number of said disk cache segments to be at least said determined number; and
read each of said unique files into a corresponding disk cache segment.

17. The system of claim 16, wherein said processor is further configured to ensure that each of said file are read sequentially.

18. The system of claim 16, wherein an entire cluster of each file is read into a file system cache.

19. The system of claim 16, wherein said processor modifies the number of disk cache segments to one more than the number of said files being concurrently accessed from a disk.

20. The system of claim 19, wherein said one more cache segment services randomly-accessed files.
